(19) United States
(12) Patent Application Publication
(10) Pub. No.: US 2024/0428158 A1
(43) Pub. Date: Dec. 26, 2024

(54) VEHICLE ASSIGNMENT QUEUE FOR SURGES AND ADVANCE RIDE REQUESTS

(71) Applicant: GM Cruise Holdings LLC, San Francisco, CA (US)

(72) Inventors: Alexander Willem Gerrese, San Francisco, CA (US); Jennifer Devar McKnew, Petaluma, CA (US); Spencer Lee James, Santa Clara, CA (US)

(73) Assignee: GM Cruise Holdings LLC, San Francisco, CA (US)

(21) Appl. No.: 18/337,661

(22) Filed: Jun. 20, 2023

(51) Int. Cl. G06Q 10/0631; G06Q 50/30; G08G 1/00; H04W 4/02; H04W 4/021

(52) U.S. Cl. CPC G06Q 10/06315; G06Q 50/40; G08G 1/202; H04W 4/021; H04W 4/023

(57) ABSTRACT

A fleet management system coordinates a fleet of vehicles to provide a ride service to users. The fleet management system can receive queue ride requests, which allows a user to join a virtual queue of riders seeking rides from a particular geographic area, such as an airport or an area around a venue. A user can submit a queue ride request before the ride is needed (e.g., when the user's flight lands at an airport), and the fleet management system can place the request in a queue based on the order in which the request was received. The fleet management system may then assign a user to a particular AV when the user is ready for the ride (e.g., when the user has reached the pickup location), and based on the user's position in the queue.

### TECHNICAL FIELD OF THE DISCLOSURE

The present disclosure relates generally to autonomous vehicles (AVs) and, more specifically, to methods and systems for queue-based dispatching and assignment of AVs providing a ride service.

### BACKGROUND

In certain situations, people know that they will be requesting a ride from a ride service before they know the precise time that they can begin the ride. For example, a ride service user flying into an airport may know that they will need a ride from the airport to a hotel or other destination, but the process of taxiing from the runway to the gate, deplaning, walking through the terminal, and, in some cases, going through passport control and/or waiting for luggage, can take a highly variable amount of time. If a user requests a ride too early, a car can arrive to pick the user up at the airport long before the user is able to reach the pickup spot. After a threshold period of time (e.g., 5 minutes), the ride service may reassign the car to a different user, and the user loses their ride and has to submit a new ride request, and, in some cases, pay a no-show fee. If the user instead waits to request a ride until they are at or nearing the pickup spot, they may have a long wait for a car to arrive. As another example, a ride service user at a sporting event may want a ride home after the end of the game, but in some sports, the exact time the game will end may be hard to predict, so the user may wait for the game to end to request a ride.

If many similarly situated users (e.g., users at the same event, or users on the same airplane) each wait until they are ready to get into a car (e.g., at a suitable pickup spot) to request a ride, it can be challenging for a vehicle fleet to respond to this sudden spike in demand. For example, if 50 users arriving on the same airplane request rides at approximately the same time, depending on the fleet distribution, it may take a long time for a vehicle fleet to send 50 cars to the airport to meet all of these requests.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system including a fleet of AVs that can be assigned to service ride requests according to some embodiments of the present disclosure;

FIG. 2 is a diagram illustrating a set of users requesting rides from a fleet management system according to some embodiments of the present disclosure;

FIG. 3 is a block diagram illustrating a fleet management system according to some embodiments of the present disclosure; and

FIG. 4 is a diagram illustrating multiple users desiring rides from multiple AVs according to some embodiments of the present disclosure;

FIG. 5 is a diagram illustrating progress of users and AVs towards a pickup spot according to some embodiments of the present disclosure;

FIG. 6 is a diagram illustrating further progress of users and AVs towards the pickup spot according to some embodiments of the present disclosure;

FIG. 7 is a diagram illustrating one user in an assigned AV and other users and AVs progressing towards the pickup spot according to some embodiments of the present disclosure;

FIG. 8 is a diagram illustrating additional users assigned to AVs at the pickup spot according to some embodiments of the present disclosure; and

FIG. 9 is a flowchart of an example process for assigning AVs to service ride requests using a queue system according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

A fleet management system described herein coordinates a fleet of autonomous vehicles (AVs) to provide a ride service to users. The fleet management system can receive queue ride requests, which allows a user to join a virtual queue of riders seeking rides from a particular geographic area, such as an airport or an area around a venue. For example, a user can submit a queue ride request to the fleet management system before the ride is needed (e.g., when the user's flight lands at an airport), and the fleet management system can assign the queue ride request to a queue based on the order in which the request was received. The fleet management system may then assign a user to a particular AV when the user is ready for the ride (e.g., when the user has reached the pickup location), and based on the user's position in the queue. As another example, a user can submit a queue ride request in a high-demand situation, such as when a large number of users in the same geographic area (e.g., a geographic area around a concert venue) submit ride requests over a short time frame.

A queue ride request includes a pickup location for the AV to pick up the user. The queue includes additional ride requests with the same pickup location, or within a certain geographic area that includes the pickup location. The fleet management system dispatches one or more AVs to drive to the pickup location or geographic area and to service ride requests in the queue.

In some embodiments, a queue ride request is a request for a ride that the user wants to start at an undefined time in the near future. The start time for the ride (e.g., the time that the user is at the pickup location and ready to begin the ride) may be tied to one or more events occurring, e.g., a sports game or concert ending, or a plane landing or de-boarding. These events may not occur on a predictable schedule, e.g., sports events may have overtime or stoppage of play that leads to delays. The start time for the ride may additionally or alternatively depend on the speed of the user's progress to the pickup location, e.g., the time for the user to walk through an airport to a rideshare pickup location, or the time for the user to exit a large arena or other venue. If the user is in an unfamiliar and/or crowded place (e.g., an unfamiliar airport), the user may not be able to accurately predict how long it takes to walk to the pickup location.

The queue feature of the fleet management system enables a user to submit a queue ride request and get in a virtual queue for a ride. In some cases, the user submits a queue ride request without specifying a precise pickup time or precise pickup window. In a high-demand situation, the user may submit a queue ride request for the next available AV, e.g., if the wait time is expected to be greater than a threshold amount of time (e.g., greater than 10 minutes or greater than 20 minutes) based on AV availability and a demand surge. In general, if a first user submits a ride request to the queue before a second user, the first user can get a ride from the first AV that arrives at the pickup location. However, assigning AVs to users strictly according to the queue order may lead to an inefficient allocation of AVs, e.g., if the second user arrives at the pickup location before the first user. The fleet management system may monitor the progress of the users towards the pickup location, e.g., by tracking a location of a user device associated with the user and/or the ride request. As a user nears or reaches the pickup location, the fleet management system can assign a specific AV to that user.

In some embodiments, the fleet management system can dynamically arrange the ride requests in the queue, e.g., based on progress of users towards the pickup location and availability of AVs for the requesting users. For example, if a first user approaches the pickup location before a second, but the second user requested a ride earlier and is earlier in a queue, and a first AV and a second AV are also both nearing the pickup location, the fleet management system can move the first user ahead of the second user in the queue and assign an earlier-arriving AV to the first user. On the other hand, if the second AV is still far from the pickup location, and the second user may arrive at the pickup location before the second AV, the fleet management system may reserve the first AV for the second user, rather than giving the first AV to the first user (who is later in the queue).

As will be appreciated by one skilled in the art, aspects of the present disclosure, in particular aspects of queue-based dispatching and assignment of AVs, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV System for Queue-Based Dispatch and Assignment

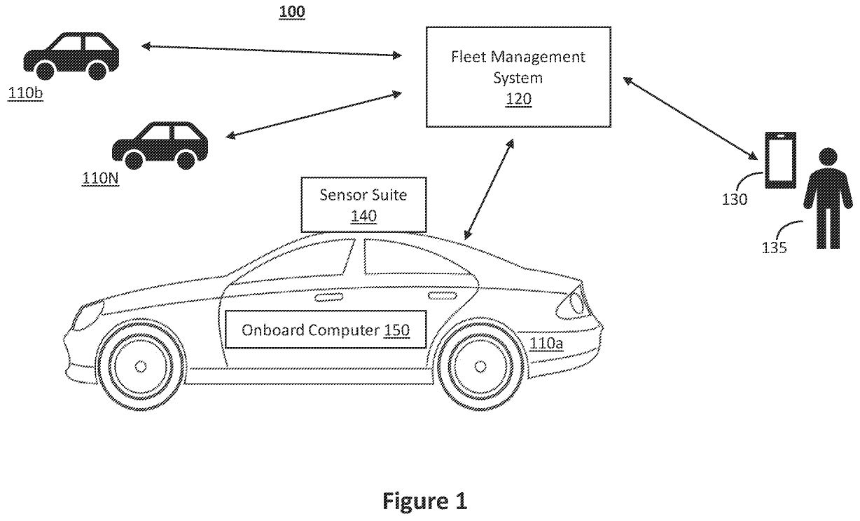

FIG. 1 is a block diagram illustrating a system 100 including an example AV fleet that can be dispatched and assigned to provide ride services, according to some embodiments of the present disclosure. The system 100 includes a fleet of AVs 110, including AV 110a, AV 110b, and AV 110N, a fleet management system 120, and a user device 130. For example, a fleet of AVs may include a number N of AVs, e.g., AV 110a through AV 110N. AV 110a includes a sensor suite 140 and an onboard computer 150. AVs 110b through 110N also include the sensor suite 140 and the onboard computer 150. A single AV in the fleet is referred to herein as AV 110, and the fleet of AVs is referred to collectively as AVs 110.

The fleet management system 120 receives service requests for the AVs from user devices, such as user device 130. For example, the user 135 accesses an app executing on the user device 130 and, using the app, enters a ride request. The user device 130 transmits the ride request to the fleet management system 120. The ride request includes at least a pickup location, e.g., the current location of the user device 130, or another location selected on a map or from a menu. In some cases, the user 135 may submit a request for a ride immediately, or as soon as an AV 110 can get to the pickup location. In other cases, the user 135 may submit a request for a ride at a specific time or specific time window (e.g., a 5-minute or 15-minute window) in the future. In still other cases, the user 135 may submit a request for a ride at an undefined or inexact time. For example, the user 135 may submit a queue ride request to join a queue for a ride, where the user can be assigned an AV 110 at the pickup location based on the user's queue position and/or a time that the user reaches the pickup location.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120 as described herein, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The AV 110 includes a sensor suite 140, which includes a computer vision (“CV”) system, localization sensors, and driving sensors. For example, the sensor suite 140 may include interior and exterior cameras, radar sensors, sonar sensors, lidar (light detection and ranging) sensors, thermal sensors, GPS, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110.

The onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

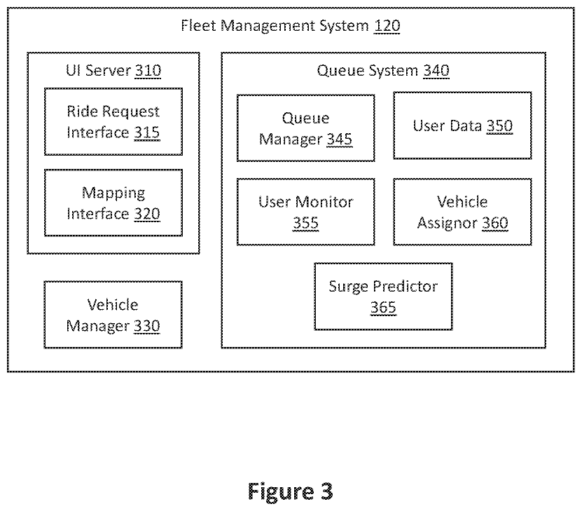

The fleet management system 120 manages the fleet of AVs 110. The fleet management system 120 may manage one or more services that provides or uses the AVs, e.g., a service for providing rides to users using the AVs. The fleet management system 120 selects an AV (e.g., AV 110a) from a fleet of AVs 110 to perform a particular service or other task, and instructs the selected AV to drive to a particular location (e.g., a pickup location of a queued ride request). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a public network, such as the Internet. The fleet management system 120 is described further in relation to FIG. 3.

The user device 130 is a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs, such as a service that provides rides using the AVs 110. The service, and particularly the AVs associated with the service, is managed by the fleet management system 120, which may also provide the application to the user device 130. The application may provide a user interface to the user 135 prior to and/or during the rides, such as information indicating a position of a user's ride request in a queue, or information describing the progress of AVs to a geographic area associated with the queued ride request.

### Example Queued Ride Request Use Case

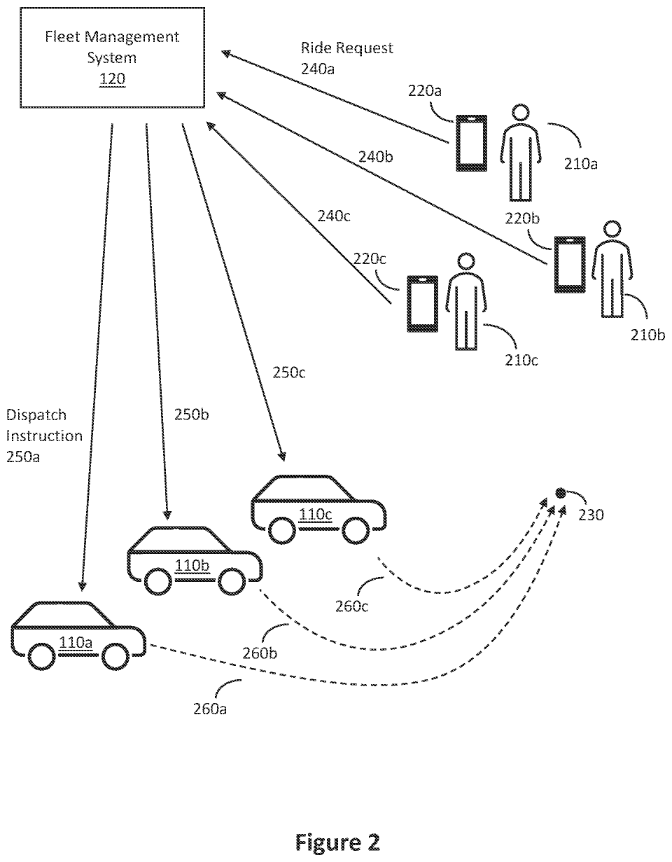

FIG. 2 is a diagram illustrating a set of users requesting rides from a fleet management system according to some embodiments of the present disclosure. In this example, a group of users 210, including users 210a, 210b, and 210c, are seeking a ride from the fleet management system 120. In this example, each of the users 210 uses a respective user device 220 to submit a respective ride request 240 to the fleet management system 120, e.g., users 210a uses user device 220a to submit ride request 240a, etc. The user devices 220 are examples of the user device 130 described with respect to FIG. 1.

Each ride request 240 includes a pickup location, and may further include other information, such as a destination location and a number of passengers. In some embodiments, a ride request 240 may indicate a request for, or willingness to accept, a shared ride with another user. In the example shown in FIG. 2, the ride requests 240 each indicate the pickup location 230, which is some distance away from each of the users 210 and user devices 220. For example, the pickup location 230 may be a designated pickup spot for ride services at an airport, a train station, a bus depot, an arena, a stadium, a hotel, an amusement park, a conference center, a movie theater, etc. In general, the pickup location 230 may be proximate to any building, venue, or other area that has a relatively large number of people who may need rides. In some embodiments, the pickup location 230 may be a location within a geographic area that may have a large number of people requesting rides, such as a nightlife district.

While in this example, each of the ride requests 240 indicates the same pickup location 230, in other example, different ride requests 240 may indicate different pickup locations within a certain geographic area, e.g., different ride service zones within an airport, different bars within a particular area of a city (e.g., along a particular stretch of a road), different entrances of a shopping mall, difference gates of a stadium, etc. The users 210 may each enter a pickup location by selecting a point on a map, by entering an address, or other means. For example, if a user's current location is within a geographic boundary of an airport, an app on the user device 220 may provide a menu allowing the user to select one of multiple pickup spots at the airport.

In response to receiving the ride requests 240, the fleet management system 120 may generate a ride request queue associated with the pickup location 230. The ride requests 240 may be added to the queue in the order that they are received at the fleet management system 120, e.g., ride request 240a, ride request 240b, ride request 240c. In general, AVs 110 can be assigned based on the order of ride requests in the queue, e.g., if the users 210a and 210b arrive at the pickup location 230 at the same time, the fleet management system 120 assigns an earlier-arriving AV to the ride request 240a, and a later-arriving AV to the ride request 240b.

The fleet management system 120 selects AVs 110 to service the ride requests 240 and transmits dispatch instructions 250 to the AVs 110. In this example, the fleet management system 120 transmits dispatch instructions 250a, 250b, and 250c to three AVs 110a, 110b, and 110c. For example, the fleet management system 120 identifies three AVs in the fleet of AVs 110 that are available and located proximate to the pickup location 230 (e.g., within a certain range of distance or drive time from the pickup location). If the fleet management system 120 expects a delay in one or more of the users 210 getting to the pickup location (e.g., if the users are waiting for a game to end and there are at least 15 minutes left in the game, or a user is at least 20 minutes walking distance from the pickup location 230), the fleet management system 120 may delay transmitting dispatch instructions 250 to one or more of the AVs 110, or not necessarily select a closest AV to the pickup location 230 to service the request, e.g., if the closest AV can service a different request. The fleet management system 120 may consider additional factors in selecting the AVs, such as fuel or battery level of the AVs, geographic distribution of AVs, and other ride requests.

The dispatch instructions 250a, 250b, and 250c instruct the selected AVs 110a, 110b, and 110c to drive autonomously to the pickup location 230. In this example, the selected AVs 110a, 110b, and 110c have different starting locations. The first selected AV 110a travels along a first route 260a to the pickup location 230, the second selected AV 110b travels along a second route 260b to the pickup location 230, and the third selected AV 110c travels along a third route 260c to the pickup location 230. The fleet management system 120 monitors the progress of the AVs 110 to the pickup location 230 and the progress of the user devices 220 (associated with the users 210) to the pickup location 230, and the fleet management system 120 assigns specific AVs to specific ride requests (associated with specific users) as the AVs and user devices reach the pickup location 230.

### Example Fleet Management System

FIG. 3 is a block diagram illustrating the fleet management system 120 according to some embodiments of the present disclosure. The fleet management system 120 includes a UI (user interface) server 310, a vehicle manager 330, and a queue system 340. The UI server 310 includes a ride request interface 315 and a mapping interface 320. The queue system 340 includes a queue manager 345, user data 350, a user monitor 355, a vehicle assignor 360, and a surge predictor 365. In alternative configurations, different and/or additional components may be included in the fleet management system 120. Further, functionality attributed to one component of the fleet management system 120 may be accomplished by a different component included in the fleet management system 120 or a different system than those illustrated.

The UI server 310 is configured to communicate with client devices that provide user interfaces to users. For example, the UI server 310 may be a web server that provides a browser-based application to client devices, or the UI server 310 may be a mobile app server that interfaces with a client app installed on client devices. The client devices include personal user devices, such as the user devices 130 and 220. The client devices may also include devices mounted in the AVs 110, such as a display screen or touch screen device mounted in the passenger compartment of an AV. In some embodiments, the fleet management system 120 includes one UI server or set of UI servers enabling user interfaces on personal devices, and another UI server or set of UI servers enabling user interfaces on in-vehicle devices.

The UI server 310 includes the ride request interface 315, which enables the users to submit requests to a ride service provided or enabled by the fleet management system 120, e.g., to request a ride from an AV 110 immediately, or to request to join a queue for a ride in the near future. Another user interface, the mapping interface 320, provides information to passengers about their locations when they are in an AV and, in some cases, provides information about the locations of other AVs 110 dispatched to service a queue. The UI server 310 may include other interface features, such as interfaces for the user to view information and adjust settings relating to the AV 110, such as routing settings, temperature settings, music selections, AV behavior, etc.

More particularly, the ride request interface 315 provides an interface through which a user can submit a ride request, such as the ride request 240 described with respect to FIG. 2. The ride request may include any of the information described with respect to FIG. 2, including a pickup location, number of passengers, and a drop-off location. In some embodiments, the ride request interface 315 includes an option to join a ride queue or submit a request to a queue. In other embodiments, the ride request interface 315 may determine to generate a queue ride request based on parameters of a ride request, e.g., if the current location of the user device is at least a threshold distance from a pickup location, or if the demand in a geographic area including the pickup location is high (e.g., the fleet management system 120 has at least a threshold (e.g., 10, 25, 50, etc.) current requests in the same geographic area, or if the fleet management system 120 estimates a time for an AV 110 to reach the pickup location to be greater than a threshold (e.g., 10 or 20 minutes). In such embodiments, the ride request interface 315 may provide an option for the user to join a queue or to request a ride at a later time, e.g., when demand is lower, or when the user is closer to the pickup location.

If the user submits a queue ride request or opts to join a queue, the ride request interface 315 may provide additional options or fields for the user to provide data that the fleet management system 120 may use to predict a time or time range for the user to arrive at the pickup location. For example, the ride request interface 315 may ask the user to provide an approximate time or earliest time that the user may reach the pickup location, or an event preceding the user arriving at the pickup location.

In some embodiments, the options may be determined based on a current location of the user, e.g., as determined by the user device. For example, if the user device has a current location in an airport, the ride request interface 315 may ask a user for information that the fleet management system 120 to predict when the user may arrive at the pickup location. For example, the ride request interface 315 may ask the user to provide flight information (e.g., arriving flight number), terminal, gate number, baggage claim number, whether the user is awaiting baggage, whether the user must go through passport control, and whether the user is traveling with a group. As another example, if the user device has a current location in a stadium, the ride request interface 315 may ask a user whether, if a game goes into overtime, the user intends to stay through overtime or plans to leave at the end of regulation.

In some cases, the fleet management system 120 may infer at least some of this data, e.g., the queue system 340 (e.g., the user monitor 355, described further below) may access one or more previous locations of the user device to determine a likely flight that the user flew on, or access user data 350 (described further below) indicating a recent ride (e.g., within the past day) to another airport, which may be an airport that the user flew out of. The ride request interface 315 may ask the user to confirm inferred information, e.g., the ride request interface 315 may suggest a flight that originated at the user device's previous location and landed in the user device's current location.

The ride request interface 315 (or another interface provided by the UI server 310) provides information to a user about the vehicle assigned to service the ride request. For example, the ride request interface 315 may provide a license plate number, vehicle name, or other vehicle information (model, color, etc.) that the user may use to identify an assigned AV. In some embodiments, AVs 110 may have lights, displays, or other elements that can be customized to a particular ride or user. For example, the ride request interface 315 may instruct a user to find the AV with a particular light color, or to find the AV with a particular word or symbol on the display.

In some embodiments, if the user's ride request is in a queue, the ride request interface 315 provides a display asking the user to confirm that the user is ready to ride prior to the queue system 340 (e.g., the vehicle assignor 360, described below) assigning a vehicle to the request. In some embodiments, the ride request interface 315 provides an option for a user to delay the ride after an AV has already been assigned to service the ride request. For example, if the user is engaged in conversation or waiting to pick up a coffee and is not ready to ride, the user may request to delay pickup by a certain amount of time (e.g., 5 minutes or 10 minutes), or the user may request to receive the next available ride. If the UI server 310 receives a refusal from the user for the assigned AV, the UI server 310 informs the vehicle assignor 360.

The mapping interface 320 generates a map that shows information about an ongoing ride, including the current location of the AV and a destination location. The map provided by the mapping interface 320 may be adjustable, e.g., the map allows the user to pan to show different regions, and to zoom in and zoom out. In some embodiments, the mapping interface 320 may provide a map to a user before a ride has started, e.g., a map showing one or more AVs at the pickup location or routing to the pickup location. For example, the mapping interface 320 may show the current location of an AV that may be assigned to the user, based on the user's current position in the queue, or the current locations of AVs dispatched to the geographic area to service ride requests in the queue.

The vehicle manager 330 manages and communicates with the fleet of AVs 110. The vehicle manager 330 generally assigns the AVs 110 to various tasks and directs the movements of the AVs 110 in the fleet. For example, the vehicle manager 330 assigns AVs 110 to service ride requests, including queue ride requests. The vehicle manager 330 instructs AVs 110 to drive to other locations while not servicing a user, e.g., to improve geographic distribution of the fleet, to anticipate demand at particular locations (e.g., as predicted by the surge predictor 365, described below), etc. The vehicle manager 330 may also instruct AVs 110 to return to an AV facility for fueling, inspection, maintenance, or storage.

More specifically, the vehicle manager 330 receives ride requests (e.g., the ride requests 240a-240c) from the ride request interface 315. The vehicle manager 330 selects AVs 110 to service the ride requests based on the information provided in the ride requests, e.g., the pickup location. The vehicle manager 330 or another system may maintain or access data describing each of the AVs in the fleet of AVs 110, including current location, service status (e.g., whether the AV is available or performing a service; when the AV is expected to become available; whether the AV is schedule for future service), fuel or battery level, etc. The vehicle manager 330 may select AVs to service ride requests in a manner that optimizes one or more factors, including fleet distribution, fleet utilization, and energy consumption. The vehicle manager 330 may interface with one or more predictive algorithms that project future service requests and/or vehicle use, and select vehicles for services based on the projections.

The vehicle manager 330 transmits instructions (e.g., the dispatch instructions 250) dispatching the selected AVs. In particular, the vehicle manager 330 instructs the selected AVs to drive autonomously to the pickup location, or in some cases, a point near to one or more pickup locations indicated by the ride requests. As a particular AV 110 approaches or reaches this point, the vehicle assignor 360 (described further below) assigns the AV 110 to a particular ride request, and the vehicle manager 330 instructs the AV 110 to drive to the specific pickup location of the ride request.

The queue system 340 manages queues of ride requests and assignments of AVs to queued ride requests. The queue system 340 includes a queue manager 345, which creates and maintains queues of ride requests within a specific geographic area, as described above. The queue manager 345 may maintain many queues associated with different geographic areas, e.g., different airports, different venues, etc. The queue manager 345 may create a new queue when demand reaches a certain level, e.g., if a number of ride requests with pickup locations in the geographic area that have not been picked up exceeds a threshold number, or an estimated time for the next available AV 110 to reach the geographic area exceeds a threshold wait time. In some cases, the queue manager 345 may create a persistent queue, e.g., for an airport, or create a queue during a set time frame, e.g., on days when a particular stadium is hosting an event.

The queue manager 345 maintains an order of ride requests for its associated geographic area. For example, the queue manager 345 may generally create first-in-first-out (FIFO) queues, where a first ride request in the queue (i.e., the earliest-received request) is assigned the first available AV (i.e., the first AV arriving at the geographic area), the second ride request is assigned the second available AV, etc. After a user has been assigned to an AV 110, the queue manager 345 may remove the ride request from the user from the queue. In some cases, the queue manager 345 may rearrange a queue order, e.g., to move up a ride request if the user is at a pickup location, or to move up a ride request if user data 350 includes a priority factor. Priority factors may include age (e.g., the user is a minor or elderly, or the ride request was submitted on behalf of a minor or elderly person) and medical conditions (e.g., a medical condition that makes it difficult to stand for an extended period of time while waiting for an AV). Priority factors may also include other disabilities, e.g., if a user is sight impaired or hearing impaired, has a chronic illness, etc. The user, a parent, or a caregiver may provide data describing and/or verifying a priority factor to the fleet management system 120, e.g., via an app or website, and the fleet management system 120 may include some or all of the data provided in the user data 350.

As noted above, in some embodiments, a user at or near the top of the queue may indicate in a UI that the user is not ready to be picked up. In this case, the queue manager 345 may move the user's ride request down by one or more positions in the queue. If the user indicates an amount of time before the user expects to be ready, the queue manager 345 may determine a position for the ride request in the queue based on the expected availability of AVs and the amount of time. For example, if, on average, one AV is arriving to pick up users in the queue per minute, and the user requests a 5 minute delay, the queue manager 345 moves the ride request down by 5 positions. As another example, if the vehicle manager 330 indicates that 7 AVs 110 are expected to arrive at the queue pickup location or area in the next 5 minutes (e.g., based on the current locations of AVs 110 assigned to service ride requests in the queue), the queue manager 345 moves the ride request down by 7 positions. In some cases, the queue manager 345 may leave the ride request in its current position (e.g., at the top of the queue), but skip past the ride request for a particular period of time (e.g., for a 5 minute period, or an amount of time requested by the user).

The user data 350 includes data relating to users that may be used by the queue system 340 to make queuing and/or assignment decisions. While the user data 350 is illustrated as being part of the queue system 340, in some embodiments, at least a portion of the user data 350 is stored outside the queue system 340 (e.g., at a separate user data store of the fleet management system 120) and accessed by the queue system 340 or various components of the queue system 340. The user data 350 may include data indicating any special needs or other conditions that the queue manager 345 may use to rearrange a queue, or that the vehicle assignor 360 may use to advance assignment for a particular user, or to assign a particular type of AV (e.g., a wheelchair accessible AV) to the user. The user data 350 may further include any stored ride data (e.g., pickup and drop off locations of previous rides), stored location data (e.g., previous locations of a user device associated with the user), and data provided by a user that may relate to rides (e.g., flight information, event tickets, calendar data, etc.).

The user monitor 355 monitors progress of users with ride requests in a queue. After the queue system 340 receives a queue ride request, the user monitor 355 may monitor the location of the user device that submitted the ride request in order to monitor the movement of the user towards the pickup location. In some embodiments, the user monitor 355 or another component accesses additional public data that may relate to a user's progress towards the pickup location and/or readiness to be picked up. For example, if the user arrived at an airport, the user monitor 355 may access public data indicating whether a plane has deboarded, whether luggage has arrived at a baggage claim, current wait time through customs, etc. For a sporting event, the user monitor 355 may access a current time remaining in the game, another progress status (e.g., baseball inning), or a current score (which may indicate a likelihood that a football game goes into overtime, or a likelihood that a tennis game may end soon, etc.).

The vehicle assignor 360 assigns AVs to ride requests in a queue. The vehicle assignor 360 receives location information of AVs dispatched to the geographic area of the pickup location, i.e., AVs dispatched to service rides in the queue. The vehicle assignor 360 compares the current location of an AV 110 to the geographic area to determine when an AV 110 is at or near the geographic area, e.g., when an AV crosses a boundary of the geographic area, when an AV crosses a boundary a set distance (e.g., 500 meters) outside from the geographic area, when an AV is expected to arrive at the geographic area within a set amount of time (e.g., 1 minute or 2 minutes), etc.). When the vehicle assignor 360 determines that an AV 110 is at or nearing the geographic area, the vehicle assignor 360 identifies a ride request in the queue for the geographic area to assign to the AV 110. For example, the vehicle assignor 360 selects the first or highest ride request in the queue.

As another example, the vehicle assignor 360 retrieves data from the user monitor 355 to determine whether the user associated with the first ride request in the queue is ready to be picked up, e.g., whether the user device associated with the first ride request is at or near the pickup location (e.g., within a 50 foot radius of the pickup location, or outside of a building or designated security area), or whether an event preceding pickup (e.g., a sports game ending) has occurred. If the user associated with the first ride request is not ready to be picked up, the vehicle assignor 360 may select the second ride request in the queue and retrieve data from the user monitor 355 to determine whether the user associated with the second ride request in the queue is ready to be picked up, etc. Before assigning an AV 110 to a later ride request in the queue, the vehicle assignor 360 may check that another AV 110 is likely to be able to pick up one or more earlier ride requests in the queue when the users are ready to be picked up.

As noted above, after the vehicle assignor 360 assigns an AV to a particular ride request, the UI server 310 (e.g., the ride request interface 315) provides information to the user device associated with the ride request regarding the user's assigned AV, e.g., a license plate number, vehicle name, or other vehicle information (model, color, etc.) that the user may use to identify an assigned AV.

In some embodiments, the UI server 310 may enable a user to refuse or delay the ride after it has been assigned by the vehicle assignor 360. For example, if the user is waiting for a coffee and is not ready to ride, the user may request to delay pickup by a certain amount of time (e.g., 5 minutes or 10 minutes), or the user may request to receive the next available ride. If the UI server 310 receives a refusal from the user for the assigned AV, the UI server 310 informs the vehicle assignor 360. The vehicle assignor 360 may then re-assign the AV 110 to a different user. For example, the vehicle assignor 360 may re-assign the AV 110 to the next user in the queue. In some situations, the next user in the queue may be at a different location from the refusing user, and the AV 110 may not be the closest AV to the next user in the queue. For example, if the refusing user is at Door 5 at a particular airport terminal, and the next user in the queue is at Door 1, the AV has to circle around the terminal to get back to Door 1, which in some situations may take several minutes. In this case, the vehicle assignor 360 may re-assign the AV to a user that is relatively high in the queue and relatively quick for the AV to reach. For example, the vehicle assignor 360 may re-assign the AV to the next user in the queue that is at the same location or approximately the same location (e.g., at the same address, within 10 meters, etc.) as the refusing user. As another example, the vehicle assignor 360 may re-assign the AV to the next user in the queue that is within a 2 minute drive (or other threshold length of time) of the current location of the AV. In response to the vehicle assignor 360 re-assigning the vehicle, the vehicle manager 330 may transmit an instruction to the AV 110 to update a display, light color, or other setting on the AV 110 based on a setting for the user that the AV 110 has been reassigned to. Furthermore, the vehicle manager 330 may transmit an instruction to the AV 110 to drive to a different location, e.g., to drive to a current location of the user associated with the next ride request in the queue.

The surge predictor 365 predicts a potential period of high demand at a specific geographic area, referred to as a surge, based on public data and/or user data. In some embodiments, the surge predictor 365 may identify one or more users based on the user data 350 that are likely to request a ride within a particular time frame. For example, if user data 350 indicates that a set of users used the ride service to travel to a stadium or other venue, the surge predictor 365 predicts that at least some of this set of users may request rides at or near the conclusion of the event at the venue. As another example, if user data indicates that a user used the ride service to travel to a regional railway station (e.g., a New Jersey station along the Port Authority Trans-Hudson (PATH) line), the surge predictor 365 predicts that this user may request a ride near the World Trade Center station in Manhattan, particularly if the user data 350 indicates that the user has previously requested rides from this station. The surge predictor 365 may aggregate data from multiple users to predict if a particular geographic area may experience a surge, e.g., during rush hour, or during an event. The surge predictor 365 may further access public data, such as sports schedules, concert schedules, etc., to predict surges at large events.

The surge predictor 365 may monitor timing data, e.g., train statuses, timetables, sporting event statuses, etc., to predict a timing for the surge. The surge predictor 365 provides information about a potential surge to the vehicle manager 330, which may instruct AVs 110 to travel to the geographic area associated with the surge in advance of the surge.

### Example Airport Queue

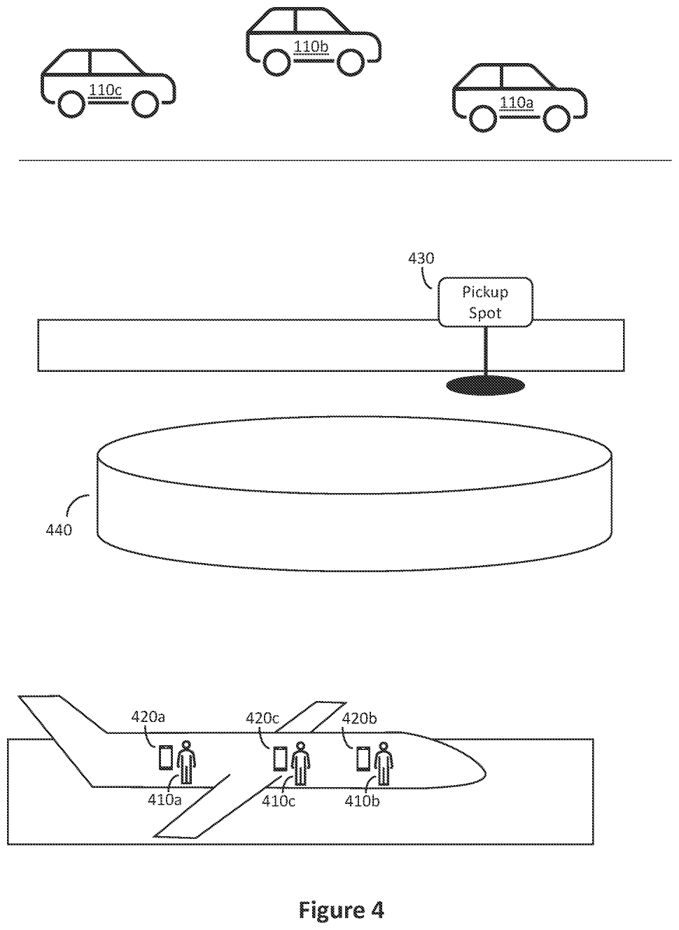

FIGS. 4-8 illustrate an example set of users that are assigned rides according to a queue according to some embodiments of the present disclosure. FIG. 4 is a diagram illustrating multiple users desiring rides from multiple AVs. In this example, three users, 410a, 410b, and 410c, each request to join a ride queue for a ride from the airport using three respective user devices 420a, 420b, and 420c. Each of the ride requests are associated with a pickup spot 430, which may be a designated rideshare pickup spot at the airport.

The three users 410a-410c have just landed at an airport and are on an airplane that is on the runway and taxiing to a gate at the terminal 440. The users 410 do not know how long it will take for the airplane to reach the gate and for them to deplane and walk through the terminal 440. However, each of the users 410 intends to take a ride from the ride service provided by the AVs 110, so the users 410 submit requests to join a queue. The ride request interface 315 may receive the request from the user device 420a first, followed by the request from the user device 420b and 420c. Thus, the queue manager 345 creates the following queue:
1. Request from 420a for user 410a
2. Request from 420b for user 410b
3. Request from 420c for user 410c.

While three requests from one airplane are illustrated in FIGS. 4-8, the queue may include more requests from other users on the airplane and/or from other airplanes.

In this example, the vehicle manager 330 dispatches three AVs 110a-110c to service rides in the queue. Each of the AVs 110a-110c may begin driving to the pickup spot 430.

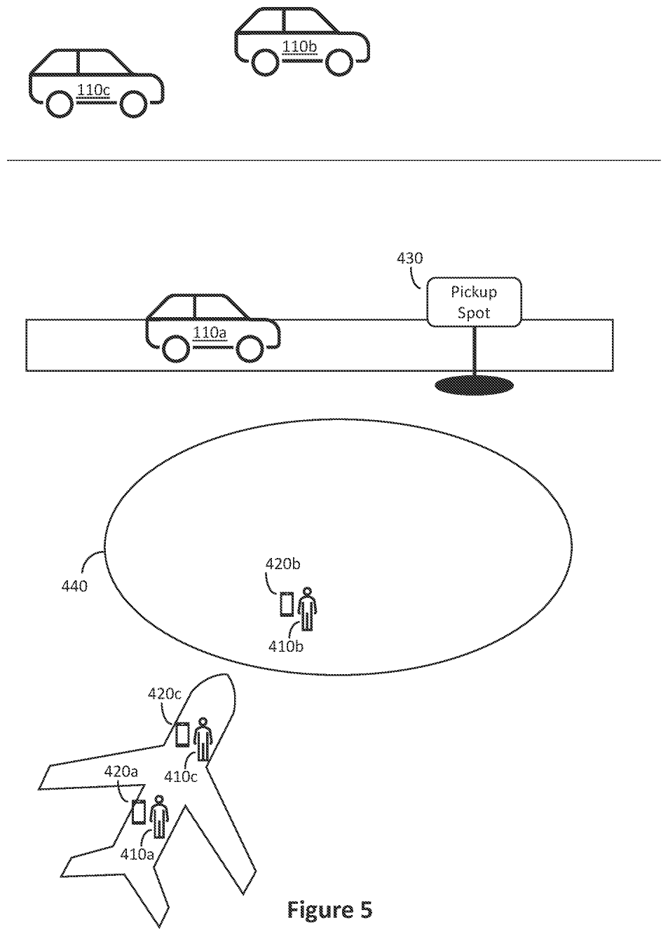

FIG. 5 is a diagram illustrating progress of users 410 and AVs 110 towards the pickup spot 430. The user 410b, located near the front of the airplane, is the first of the three users 410 off the airplane. The user monitor 355 tracks the movement of the user 410b (via the user device 420b) through the terminal 440 as the user device 420b gets closer to the pickup spot 430. The user monitor 355 may also determine that the users 410c and 410a are still on the airplane based on the locations of the user devices 420c and 420a. FIG. 5 also illustrates that a first AV 110a is approaching the pickup spot 430. The other AVs 110b and 110c are still en route to the pickup spot 430. The vehicle manager 330 may track the current locations of the AVs 110, as described above.

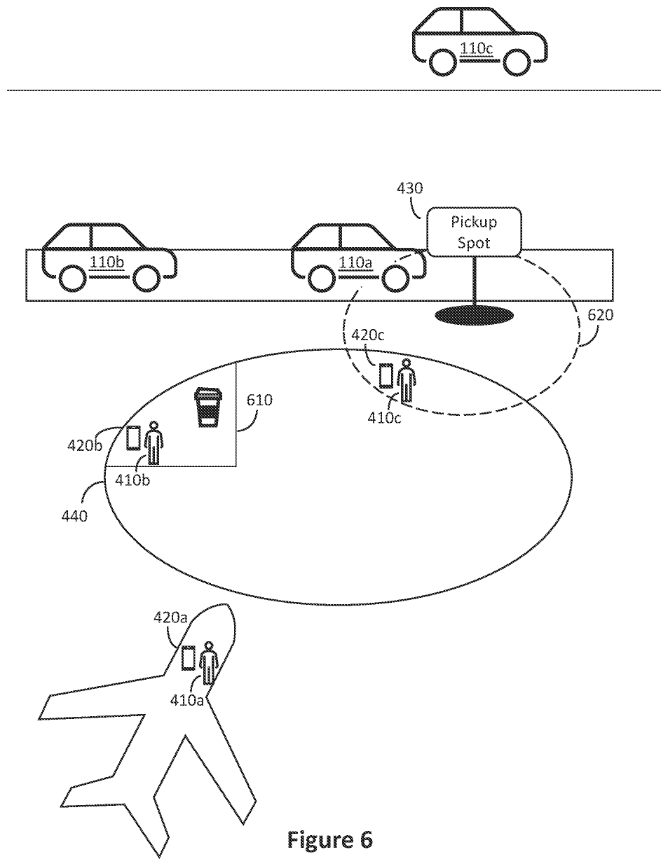

FIG. 6 is a diagram illustrating further progress of users 410 and AVs 110 towards the pickup spot 430. The user 410b stopped at a café 610, halting the progress of the user 410b towards the pickup spot 430. The user 410c has walked through terminal 440. The user 410a is still on the airplane. The user monitor 355 receives the locations of the respective user devices 420a-420c to track the locations of the users 410a-410c. The vehicle manager 330 concurrently tracks the current locations of the AVs 110a-110c, and determines that the AVs 110a and 110b are both approaching the pickup spot 430.

Based on the progress of the user device 420c, the delay of the user device 420b, and the progress of the three AVs 110a-110c towards the pickup spot 430, the queue manager 345 may move the user device 420c up in the queue, thus re-ordering the queue as follows:
1. Request from 420c for user 410c
2. Request from 420a for user 410a
3. Request from 420b for user 410b.

The user monitor 355 or the vehicle assignor 360 determines, based on the location of the user device 420c, that the user 410c is within an area 620 near the pickup spot 430. The area 620 may be an area within a threshold distance (e.g., 20 feet, 50 feet, etc.) of the pickup spot 430. In some embodiments, the area 620 is also the geographic area associated with the queue, e.g., a particular zone for rideshare pickup at an airport, an area around a particular stadium door, etc.

The vehicle assignor 360 also determines that the AV 110a is nearest to the pickup spot 430. Based on this information, the vehicle assignor 360 assigns the user 410c, who is currently first in the queue, to the AV 110a. The queue manager 345 removes the ride request from the device 420c from the queue, leaving the following queue:
1. Request from 420a for user 410a
2. Request from 420b for user 410b.

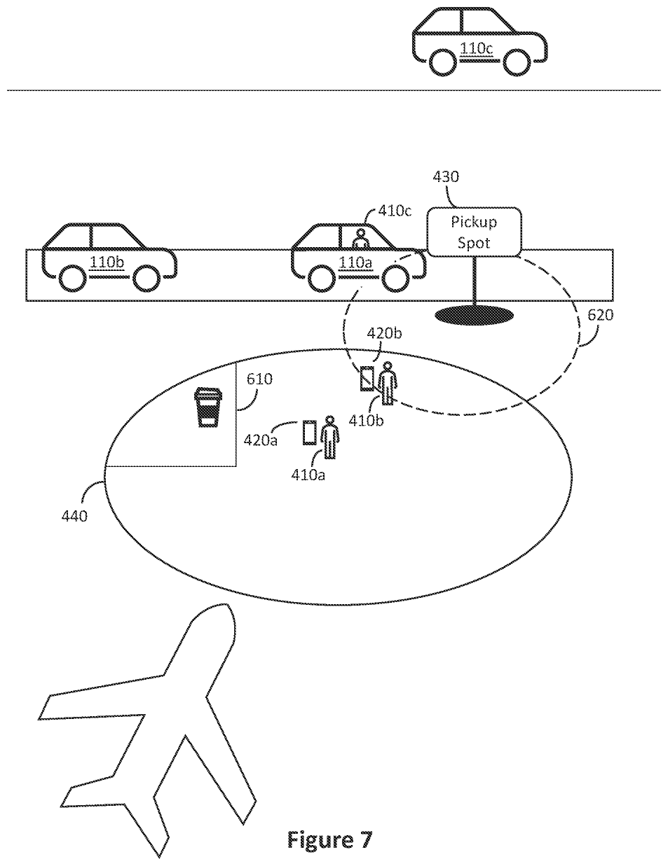

FIG. 7 is a diagram illustrating the user 410a in the assigned AV 110a and other users and AVs progressing towards the pickup spot 430. In FIG. 7, the user 410b, who had stopped in the café 610, is now entering the area 620 near the pickup spot. The user 410a is walking through the terminal 440 and is close behind the user 410b. One AV 110b is nearing the pickup spot 430, while AV 110c is still some distance away. As before, the user monitor 355 receives the locations of the user devices 420a and 420b to track the locations of the users 410a and 410b, while the vehicle manager 330 tracks the locations of the AVs 110b and 110c.

In this example, even though the user monitor 355 and/or queue manager 345 expects the user 410b to exit the terminal 440 and reach the pickup spot before the user 410a, the queue manager 345 may maintain the current queue:
1. Request from 420a for user 410a
2. Request from 420b for user 410b.

The queue manager 345 may maintain the current queue because, if the user 410b is moved forward in the queue and assigned the AV 110b, this may result in the user 410a waiting at the pickup spot 430 for the next AV 110c to reach the pickup spot 430. In other embodiments, this is an acceptable outcome, and the queue manager 345 may move the user 410b forward in the queue, e.g., when the user 410b reaches the area 620.

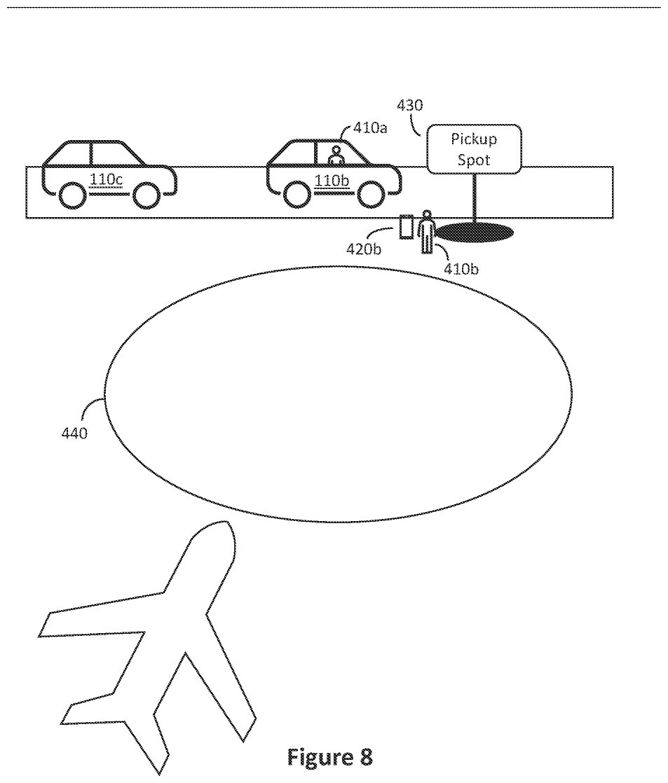

FIG. 8 is a diagram illustrating the users 410a and 410b assigned to the AVs 110b and 110c at the pickup spot 430. As the user 410a reaches the pickup spot 430 (e.g., enters the area 620), the vehicle assignor 360 determines that the AV 110b is nearest to the pickup spot 430 and assigns the user 410a, who is currently first in the queue, to the AV 110b. The queue manager 345 removes the ride request from the device 420a from the queue, leaving only the ride request from the user device 420b in the queue. The vehicle assignor 360 then determines that, of the unassigned AVs, the AV 110c is nearest to the pickup spot 430 and assigns the user 410b, who is now first in the queue, to the AV 110c. The queue manager 345 removes the ride request from the user device 420b from the queue.

### Example Method for Assigning AVs to Ride Requests in a Queue

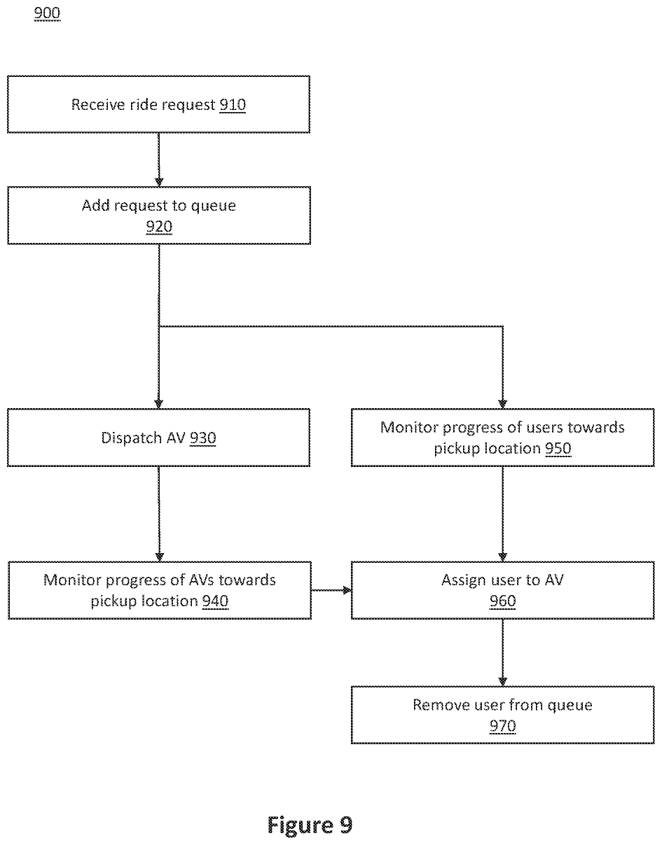

FIG. 9 is a flowchart of an example process 900 for assigning AVs to service ride requests using a queue system according to some embodiments of the present disclosure. A fleet management system 120 (e.g., a ride request interface 315 of a UI server 310) receives 910 a ride request. The ride may be a request to join a queue, or the fleet management system 120 may automatically add the request to a queue or request via the user interface that the user add the request to an existing queue.

The fleet management system 120 (e.g., the queue manager 345 of a queue system 340) adds 920 the ride request to a queue. For example, the queue manager 345 adds the ride request to an existing queue associated with the pickup location indicated in the ride request, or a geographic area that includes the pickup location.

The fleet management system 120 (e.g., a vehicle manager 330) dispatches 930 an AV 110 based on the ride request. The fleet management system 120 may dispatch the AV based on an estimated time for the user to reach the pickup location; for example, the vehicle manager 330 may delay dispatching the AV 110, rather than dispatching the AV 110 right away, if the user is expected to not reach the pickup location for a certain amount of time. On the other hand, if many users are joining the queue at around the same time, or expected to join a queue (e.g., if the surge predictor 365 determines that an event has just ended, or a large flight has landed), the vehicle manager 330 may request many available AVs head to the pickup location or an area near the pickup location to prepare for the surge of ride requests.

The fleet management system 120 monitors 940 the progress of AVs 110 towards the pickup location. For example, the vehicle manager 330 obtains current locations from the AVs 110 dispatched to the pickup location.

Concurrently, the fleet management system 120 (e.g., the user monitor 355) monitors 950 the progress of users towards the pickup location. For example, the user monitor 355 obtains current locations from user devices 220 or 420 that submitted ride requests.

Based on the progress of the AVs 110 and the users, the fleet management system 120 (e.g., the vehicle assignor 360) assigns 960 a user who submitted a ride request to a particular AV 110. For example, if the user arrives near the pickup location, and is first in the queue, the vehicle assignor 360 assigns a vehicle to service the ride requested by the user. In some cases, the vehicle assignor 360 may pull a lower user in the queue, e.g., to begin moving AVs 110 through the pickup location to avoid congestion, if the user has any special needs or other considerations, or if users higher in the queue are some distance away from the pickup location.

After assigning the AV to the user, the fleet management system 120 (e.g., the queue manager 345) removes 370 the user and/or the ride request associated with the user from the queue.

### Select Examples

Example 1 provides method that includes receiving a ride request from a user device associated with a user, the ride request including a pickup location, where the user device is at a first location, the first location at least a threshold distance away from the pickup location; assigning the ride request to a queue, the queue including a plurality of ride requests associated with a geographic area that includes the pickup location; receiving a second location from the user device; determining that the second location is within the threshold distance of the pickup location; and in response to determining that the second location is within the threshold distance, assigning a vehicle to pick up the user at the pickup location, the vehicle assigned based on a position of the ride request in the queue.

Example 2 provides the method of example 1, further including after receiving the first location and prior to receiving the second location, receiving a third location from the user device, the third location at least the threshold distance away from the pickup location; and adjusting a position of the ride request in the queue based on the third location.

Example 3 provides the method of example 2, where the queue includes a second ride request from a second user device, the third location is nearer to the geographic area than a current location of the second user device, and adjusting the position of the ride request includes moving the ride request higher in the queue than the second ride request.

Example 4 provides the method of example 1, where the ride request is a first ride request and the vehicle is a first vehicle, the method further including receiving a second ride request from a second user device, the second ride request received after the first ride request; assigning the second ride request to the queue; determining that the second user device is expected to reach the threshold distance of the pickup location within a threshold time of the user device reaching the threshold distance of the pickup location; and assigning a second vehicle to the second ride request, the second vehicle expected to reach the pickup location after the first vehicle.

Example 5 provides the method of example 1, where determining that the second location is within the threshold distance of the pickup location includes determining that the second location is within a boundary of the geographic area.

Example 6 provides the method of example 1, where the vehicle is a first vehicle of a fleet of AVs and the ride request is a first ride request, the method further including in response to receiving the first ride request, selecting a second vehicle from the fleet of AVs based on a location of the second vehicle; instructing the second vehicle to drive to the geographic area; assigning the second vehicle to a second ride request; and assigning the first vehicle to the first ride request.

Example 7 provides the method of example 1, further including identifying a set of potential users of a ride service proximate to the geographic area; identifying an event occurring within or near the geographic area; determining a time for picking up one or more users from the geographic area based on a status of the event; and assigning a set of vehicles including the vehicle to drive to the geographic area.

Example 8 provides the method of example 7, where the event is an estimated arrival time for public transportation, and the set of potential users includes users who used the ride service for transportation to a departure point of the public transportation.

Example 9 provides the method of example 7, where the event is a sporting event, and the status of the event includes an estimated time remaining in the sporting event.

Example 10 provides the method of example 1, further including retrieving user data for the user, the user data including a priority factor for the user to be assigned an AV ahead of another user; and adjusting a position of the ride request in the queue based on the priority factor.

Example 11 provides a computer-implemented system that includes a UI server configured to receive a ride request from a user device associated with a user, the user device at a first location, the ride request including a pickup location at least a threshold distance away from the first location, the pickup location associated with a ride queue; and a queue system configured to assign the ride request to the ride queue, the ride queue including a plurality of ride requests associated with a geographic area that includes the pickup location; receive a second location from the user device; determine that the second location is within the threshold distance of the pickup location; and in response to determining that the second location is within the threshold distance, assign a vehicle to pick up the user at the pickup location, the vehicle assigned based on a position of the ride request in the ride queue.

Example 12 provides the system of example 11, the queue system further configured to receive a third location from the user device, the third location at least the threshold distance away from the pickup location, the third location received after receiving the first location and prior to receiving the second location; and adjust a position of the ride request in the ride queue based on the third location.

Example 13 provides the system of example 12, where the ride queue includes a second ride request from a second user device, the third location is nearer to the geographic area than a current location of the second user device, and adjusting the position of the ride request includes moving the ride request higher in the ride queue than the second ride request.

Example 14 provides the system of example 11, where the ride request is a first ride request and the vehicle is a first vehicle, the UI server further configured to receive a second ride request from a second user device, the second ride request received after the first ride request, and the queue system further configured to assign the second ride request to the ride queue; determine that the second user device is expected to reach the threshold distance of the pickup location within a threshold time of the user device reaching the threshold distance of the pickup location; and assign a second vehicle to the second ride request, the second vehicle expected to reach the pickup location after the first vehicle.

Example 15 provides the system of example 11, where determining that the second location is within the threshold distance of the pickup location includes determining that the second location is within a boundary of the geographic area.

Example 16 provides the system of example 11, where the vehicle is a first vehicle of a fleet of AVs and the ride request is a first ride request, the system further including a vehicle manager configured to select a second vehicle from the fleet of AVs based on a location of the second vehicle in response to receiving the first ride request; and instruct the second vehicle to drive to the geographic area; where the queue system is further configured to assign the second vehicle to a second ride request, and assign the first vehicle to the first ride request.

Example 17 provides the system of example 11, the queue system further to identify potential users of a ride service proximate to the geographic area; identify an event occurring within or near the geographic area; determine a time for picking up one or more users from the geographic area based on a status of the event; and assign a set of vehicles including the vehicle to drive to the geographic area.

Example 18 provides a non-transitory computer-readable medium storing instructions that, when executed by a processor, cause the processor to receive a ride request from a user device associated with a user, the ride request including a pickup location, where the user device is at a first location, the first location at least a threshold distance away from the pickup location; assign the ride request to a queue, the queue including a plurality of ride requests associated with a geographic area that includes the pickup location; receive a second location from the user device; determine that the second location is within the threshold distance of the pickup location; and in response to determining that the second location is within the threshold distance, assign a vehicle to pick up the user at the pickup location, the vehicle assigned based on a position of the ride request in the queue.

Example 19 provides the non-transitory computer-readable medium of example 18, where the instructions further cause the processor to receive a third location from the user device, the third location at least the threshold distance away from the pickup location, the third location received after receiving the first location and prior to receiving the second location; and adjust a position of the ride request in the queue based on the third location.

Example 20 provides the non-transitory computer-readable medium of example 18, where the ride request is a first ride request and the vehicle is a first vehicle, and the instructions further cause the processor to receive a second ride request from a second user device, the second ride request received after the first ride request; assign the second ride request to the queue; determine that the second user device is expected to reach the threshold distance of the pickup location within a threshold time of the user device reaching the threshold distance of the pickup location; and assign a second vehicle to the second ride request, the second vehicle expected to reach the pickup location after the first vehicle.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method comprising:
receiving a ride request from a user device associated with a user, the ride request comprising a pickup location, wherein the user device is at a first location, the first location at least a threshold distance away from the pickup location;
assigning the ride request to a queue, the queue comprising a plurality of ride requests associated with a geographic area that includes the pickup location;
receiving a second location from the user device;
determining that the second location is within the threshold distance of the pickup location; and
in response to determining that the second location is within the threshold distance, assigning a vehicle to pick up the user at the pickup location, the vehicle assigned based on a position of the ride request in the queue.

2. The method of claim 1, further comprising:
after receiving the first location and prior to receiving the second location, receiving a third location from the user device, the third location at least the threshold distance away from the pickup location; and
adjusting a position of the ride request in the queue based on the third location.

3. The method of claim 2, wherein the queue comprises a second ride request from a second user device, the third location is nearer to the geographic area than a current location of the second user device, and adjusting the position of the ride request comprises moving the ride request higher in the queue than the second ride request.

4. The method of claim 1, wherein the ride request is a first ride request and the vehicle is a first vehicle, the method further comprising:
receiving a second ride request from a second user device, the second ride request received after the first ride request;
assigning the second ride request to the queue;
determining that the second user device is expected to reach the threshold distance of the pickup location within a threshold time of the user device reaching the threshold distance of the pickup location; and
assigning a second vehicle to the second ride request, the second vehicle expected to reach the pickup location after the first vehicle.

5. The method of claim 1, wherein determining that the second location is within the threshold distance of the pickup location comprises determining that the second location is within a boundary of the geographic area.

6. The method of claim 1, wherein the vehicle is a first vehicle of a fleet of autonomous vehicles (AVs) and the ride request is a first ride request, the method further comprising:
in response to receiving the first ride request, selecting a second vehicle from the fleet of AVs based on a location of the second vehicle;
instructing the second vehicle to drive to the geographic area;
assigning the second vehicle to a second ride request; and
assigning the first vehicle to the first ride request.

7. The method of claim 1, further comprising:
identifying a set of potential users of a ride service proximate to the geographic area;
identifying an event occurring within or near the geographic area;
determining a time for picking up one or more users from the geographic area based on a status of the event; and
assigning a set of vehicles including the vehicle to drive to the geographic area.

8. The method of claim 7, wherein the event is an estimated arrival time for public transportation, and the set of potential users comprises users who used the ride service for transportation to a departure point of the public transportation.

9. The method of claim 7, wherein the event is a sporting event, and the status of the event comprises an estimated time remaining in the sporting event.

10. The method of claim 1, further comprising:
retrieving user data for the user, the user data including a priority factor for the user to be assigned an AV ahead of another user; and
adjusting a position of the ride request in the queue based on the priority factor.

11. A computer-implemented system comprising:
a user interface (UI) server configured to receive a ride request from a user device associated with a user, the user device at a first location, the ride request comprising a pickup location at least a threshold distance away from the first location, the pickup location associated with a ride queue; and
a queue system configured to:
assign the ride request to the ride queue, the ride queue comprising a plurality of ride requests associated with a geographic area that includes the pickup location;
receive a second location from the user device;
determine that the second location is within the threshold distance of the pickup location; and
in response to determining that the second location is within the threshold distance, assign a vehicle to pick up the user at the pickup location, the vehicle assigned based on a position of the ride request in the ride queue.

12. The system of claim 11, the queue system further configured to:
receive a third location from the user device, the third location at least the threshold distance away from the pickup location, the third location received after receiving the first location and prior to receiving the second location; and
adjust a position of the ride request in the ride queue based on the third location.

13. The system of claim 12, wherein the ride queue comprises a second ride request from a second user device, the third location is nearer to the geographic area than a current location of the second user device, and adjusting the position of the ride request comprises moving the ride request higher in the ride queue than the second ride request.

14. The system of claim 11, wherein the ride request is a first ride request and the vehicle is a first vehicle, the UI server further configured to receive a second ride request from a second user device, the second ride request received after the first ride request, and the queue system further configured to:
assign the second ride request to the ride queue;
determine that the second user device is expected to reach the threshold distance of the pickup location within a threshold time of the user device reaching the threshold distance of the pickup location; and
assign a second vehicle to the second ride request, the second vehicle expected to reach the pickup location after the first vehicle.

15. The system of claim 11, wherein determining that the second location is within the threshold distance of the pickup location comprises determining that the second location is within a boundary of the geographic area.

16. The system of claim 11, wherein the vehicle is a first vehicle of a fleet of autonomous vehicles (AVs) and the ride request is a first ride request, the system further comprising:
a vehicle manager configured to:
select a second vehicle from the fleet of AVs based on a location of the second vehicle in response to receiving the first ride request; and
instruct the second vehicle to drive to the geographic area;
wherein the queue system is further configured to assign the second vehicle to a second ride request, and assign the first vehicle to the first ride request.

17. The system of claim 11, the queue system further to:
identify potential users of a ride service proximate to the geographic area;
identify an event occurring within or near the geographic area;
determine a time for picking up one or more users from the geographic area based on a status of the event; and
assign a set of vehicles including the vehicle to drive to the geographic area.

18. A non-transitory computer-readable medium storing instructions that, when executed by a processor, cause the processor to:
receive a ride request from a user device associated with a user, the ride request comprising a pickup location, wherein the user device is at a first location, the first location at least a threshold distance away from the pickup location;
assign the ride request to a queue, the queue comprising a plurality of ride requests associated with a geographic area that includes the pickup location;
receive a second location from the user device;
determine that the second location is within the threshold distance of the pickup location; and
in response to determining that the second location is within the threshold distance, assign a vehicle to pick up the user at the pickup location, the vehicle assigned based on a position of the ride request in the queue.

19. The non-transitory computer-readable medium of claim 18, wherein the instructions further cause the processor to:
receive a third location from the user device, the third location at least the threshold distance away from the pickup location, the third location received after receiving the first location and prior to receiving the second location; and
adjust a position of the ride request in the queue based on the third location.

20. The non-transitory computer-readable medium of claim 18, wherein the ride request is a first ride request and the vehicle is a first vehicle, and the instructions further cause the processor to:
receive a second ride request from a second user device, the second ride request received after the first ride request;
assign the second ride request to the queue;
determine that the second user device is expected to reach the threshold distance of the pickup location within a threshold time of the user device reaching the threshold distance of the pickup location; and
assign a second vehicle to the second ride request, the second vehicle expected to reach the pickup location after the first vehicle.
